(19) United States
(12) Patent Application Publication
(10) Pub. No.: US 2019/0382130 A1
(43) Pub. Date: Dec. 19, 2019

(54) AIRBORNE STRUCTURE ELEMENT WITH EMBEDDED METAL BEAM

(71) Applicant: EVIATION TECH LTD, Kadima (IL)

(72) Inventor: Omer BAR YOHAI, Sdeh Itzhak (IL)

(73) Assignee: EVIATION TECH LTD, Kadima (IL)

(21) Appl. No.: 16/489,702

(22) PCT Filed: Feb. 28, 2018
(86) PCT No.: PCT/IL2018/050223

§ 371 Date: Aug. 29, 2019

Related U.S. Application Data
(60) Provisional application No. 62/465,185, filed on Mar. 1, 2017.

(51) Int. Cl. B64D 45/02; B64C 1/38; B64D 15/00; B64D 33/08

(52) U.S. Cl. CPC B64D 45/02; B64D 33/08; B64D 15/00; B64C 1/38

(57) ABSTRACT

An airborne vehicle made of thermally non-conductive materials and method for thermal conduction in an airborne vehicle are disclosed. The airborne vehicle comprising at least one structural element made of material with high thermal conductivity coefficient embedded in the airborne vehicle body. In some embodiments wherein the thermally conductive structural element is a longitudinal profile with hollow center along it. The method comprising disposing structural element with high thermal conductivity embedded in the airborne vehicle and providing thermal pass with high thermal conductivity from the heat source to the structural element with high thermal conductivity, to allow heat to dissipate through the structural element with high thermal conductivity.

### BACKGROUND OF THE INVENTION

Modern airborne vehicles are commonly produced of advanced composite materials such as carbon fiber layers that enable achieving high strength and flexibility with low self-weight. Yet, vehicles made of thermally non-conductive materials, such as composite materials, have certain disadvantages such as low heat dissipation rate and the like.

### SUMMARY OF THE INVENTION

An airborne vehicle made of thermally non-conductive materials is disclosed comprising at least one structural element made of material with high thermal conductivity coefficient embedded in, or otherwise made part of the airborne vehicle body. According to some embodiments the thermally conductive structural element is a longitudinal profile with hollow center along it.

According to some embodiments the thermally conductive structural element is used for at least one of: conducting heat, conducting hydrogen, conducting electrical current, conducting coolant fluid and accommodating pipe and/or cable.

According to some embodiments the thermally conductive structural element is used as an antenna pole.

According to some embodiments the thermally conductive structural element is used for electrostatic discharging.

According to some embodiments the thermally conductive structural element is used to provide additional structural strength to the vehicle body.

According to some embodiments the thermally conductive structural element is affixed to the vehicle body at locations selected to dampen tendency of the vehicle to vibrate.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 schematically presents a partial wing profile made of composite material with longitudinal thermally conductive material embedded in it, according to embodiments of the present invention;

FIG. 2 is a schematic illustration of airborne vehicle 200 adapted to dissipate heat according to embodiments of the present invention; and

FIG. 3 is a schematic electrical scheme of an airborne vehicle, according to embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Light weight airborne vehicles are commonly made of, or at least include large number of structure elements, made of advanced strong and light-weight materials such as composite materials. Many airborne vehicles comprise one or more major heat sources, such as internal combustion engine, fuel-cells, metal-air cells, and the like. When such heat sources are part of an airborne vehicle made of thermally non-conductive materials such as advanced composite materials it may be required to provide heat dissipation path in order to prevent heat run-away. When the vehicle is formed substantially as a closed body around the heat source, such heat dissipation turns into an even bigger engineering issue.

According to embodiments of the present invention one or more structure elements made of thermally conductive material may be integrated into the structure of the vehicle in a manner that may contribute to the heat dissipation, along with contribution to the combined structure strength and the structure strength versus structure weight figure. For example, the thermally conducting structure element may be made of aluminum, magnesium or the like. The thermally conductive structure element may be designed to decrease—as much as possible—the heat path resistance from the heat source on the vehicle to the ambient environment.

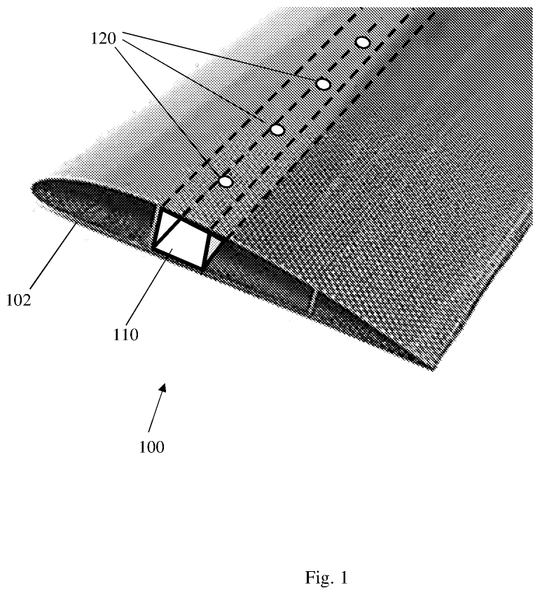

Reference is made to FIG. 1 which schematically presents a partial wing profile 100 made of composite material with longitudinal element made of thermally conductive material embedded in it, according to embodiments of the present invention. Wing profile 100 comprise aerodynamic wing element 102, thermally conductive structure element (TCSE) 110 and affixing means 120. TCSE 110 may be affixed to wing element 102 in a way that suits the structure design. For example, if TCSE 110 is designed to add structural strength to wing element 102 it may be affixed to wing element 102 in a way that will support providing enhanced structural load bearing capability to wing profile 100. The selection of affixing means and method may take into consideration one or more from the following issues: heat conduction to the environment, damping of structure vibrations (for example—selecting the locations and the distances between affixing rivets according to the wing element physical self-resonance frequency in view of the nature of physical loads acting on the wing element), visibility (in the visible range and in the Radar range), additional uses that may be assigned to TCSE 110 (such as using it as an electrical conduit or as a RF antenna or reference plane for RF antenna, or the like).

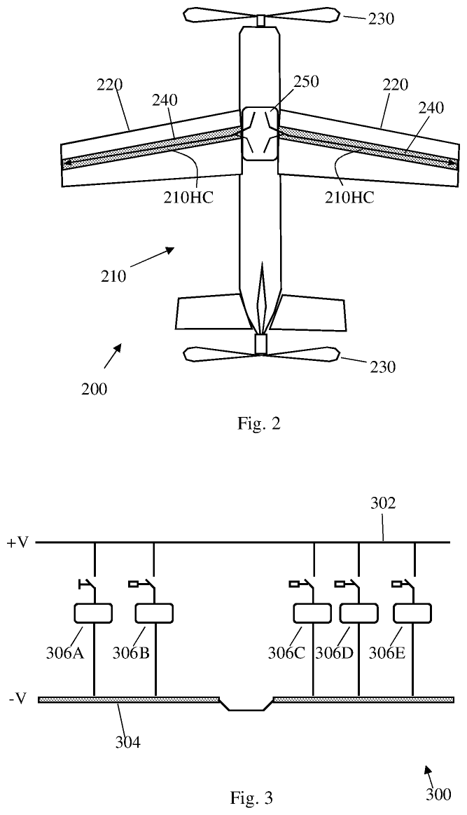

As thermal conductor TCSE 110 may be used to dissipate heat from heat sources located inside or at the airborne vehicle's body to the colder ambient, to convey heat to vehicle's limbs acting as de-icing means. In alternative or additional embodiments thermal conductor TCSE 110 may be used to convey heat from the environment into the airborne vehicle, for example for heating frozen elements; heating batteries to improve efficiency; heating elements that require specific temperature for operation, such as IMU (inertial management unit); heating payload that requires specific temperature (for either operation or storage). For example, during very high altitude flights, where the solar heating effect of direct exposure to sun rays is significant, dark areas of the composite material that touch the outer face of TCSE 110 may heat TCSE 110 and this energy may be conducted into the airborne vehicle. Reference is made to FIG. 2, which is a schematic illustration of airborne vehicle 200 adapted to dissipate heat according to embodiments of the present invention. Airborne vehicle 200 comprise vehicle fuselage 210, main wings 220, wing stabilizing and steering assembly 225, thrust means 230 and power source 250. Vehicle 200 further comprise at least one TCSE element 240 embedded, in the example of FIG. 2, in main wing 220. Vehicle 200 may be made of materials with low thermal conduction/convection figure and may contain, disposed on board heat dissipating units such as power source 250 (e.g. metal-air cell or the like). The heat produced by the heat source should be removed to ensure heat stability inside/on-board the airborne vehicle. Since the vehicle is made of low thermal conductivity material heat produced by on-board heat sources may be removed, dissipated to the environment or otherwise controlled to prevent heat runaway by directing the heat to TCSE element 240 (e.g. metal beam embedded in main wing 220) so that it flows along heat path 210HC thereby dissipating along the wing and possibly through its tip to the surrounding environment.

According to some embodiments of the invention TCSE 110 (FIG. 1) or TSCE 240 (FIG. 2) may be used as a massive electrical conductor, for example—used as the common line of the entire electrical system in the airborne vehicle, sue to its high current conduction capability. Reference is made now to FIG. 3, which is a schematic electrical scheme 300 of an airborne vehicle, according to embodiments of the present invention. Electrical scheme 300 comprise main +V bus 302, main −V bus 304 and a plurality on-board electrical loads 306A-306E connected between the main busses. In an airborne vehicle such as vehicle 200 of FIG. 2, one of the main electrical busses, e.g. −V bus, may be embodied using at least one of the HCSE 240 as a main bus, thereby saving the excess weight of a dedicated main bus made in a different manner

According to some embodiments HCSE 110 (FIG. 1) or HSCE 240 (FIG. 2) may be used as coolant conduit, or may have disposed in it coolant conduits, usable to convey in it coolant fluids such as Glycol, water, ammonia and the like. For this HSCE 110 (FIG. 1) or HSCE 240 (FIG. 2) may have longitudinal hollow center (or, more precisely—may have respectively thin envelope faces surrounding a hollow center) which may be used to conduct coolant fluid.

According to some embodiments HCSE 110 (FIG. 1) or HSCE 240 (FIG. 2) may be used as a conduit to convey hydrogen, for example hydrogen that is released during operation of a meta-air cell. HSCE 100 (FIG. 1) or HSCE 240 (FIG. 2) may then be used to convey the hydrogen through wing element 100 or wing element 220 from the metal-air cell located near the center of the airborne vehicle to the environment though suitable apertures made along the wing element and/or at its outer tip, thereby saving the extra weight of a dedicated conduit.

According to some embodiments HCSE 110 (FIG. 11) or HSCE 240 (FIG. 2) may form, or be part of electrostatic discharge path, usable to discharge electrostatic charges collected on electrically non-conductive areas, for example through dedicated electrical path at the landing gear, to the ground, thereby preventing electrostatic-related damages and hazards.

According to some embodiments HCSE 110 (FIG. 11) or HSCE 240 (FIG. 2) may be used, additionally or alternatively to the uses detailed above, as an installation means for installing cabling and/or piping of airborne vehicle 100/200, thereby saving the excess weight of dedicated installation means.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. An airborne vehicle made of thermally non-conductive materials comprising:
at least one structural element made of material with high thermal conductivity coefficient embedded in the airborne vehicle body.

2. The vehicle of claim 1 wherein the thermally conductive structural element is a longitudinal profile with hollow center along it.

3. The vehicle of claim 2 wherein the thermally conductive structural element is used for at least one of: conducting heat, conducting hydrogen, conducting electrical current, conducting coolant fluid and accommodating pipe and/or cable.

4. The vehicle of claim 1 wherein the thermally conductive structural element is used as an antenna pole.

5. The vehicle of claim 1 wherein the thermally conductive structural element is used for electrostatic discharging.

6. The vehicle of claim 1 wherein the thermally conductive structural element is used to provide additional structural strength to the vehicle body.

7. The vehicle of claim 5 wherein the electrostatic discharge is performed via the thermally conductive structural element that is connected to the landing gear of the vehicle.

8. The vehicle of claim 1 wherein the thermally conductive structural element is affixed to the vehicle body at locations selected to dampen tendency of the vehicle to vibrate.

9. The vehicle of claim 1 wherein the thermally conductive structural element is made of metal.

10. The vehicle of claim 3 wherein the hydrogen is a product of the operation of a metal-air cell.

11. The vehicle of claim 3 wherein the hydrogen is used in the operation of a hydrogen power cell.

12. The vehicle of claim 1 wherein the thermally conductive structural element is used to eliminate icing on the wing.

13. The vehicle of claim 1 wherein the thermally conductive structural element is used as lightning rod to divert lightning away from electrically sensitive zones in the vehicle.

14. A method for thermal conduction in an airborne vehicle made of low thermal conductivity, the method comprising:
disposing structural element with high thermal conductivity embedded in the airborne vehicle; and
providing thermal pass with high thermal conductivity from the heat source to the structural element with high thermal conductivity, to allow heat to dissipate through the structural element with high thermal conductivity.

15. The method of claim 14 further comprising connecting the structural element with high thermal conductivity as an electrical current bus in an electrical system of the airborne vehicle.

16. The method of claim 14 further comprising disposing the structural element with high thermal conductivity in the airborne vehicle, with respect to electrically sensitive zones in the vehicle, so as to guide lightning strike away from these zones.

17. The method of claim 14 further comprising disposing the structural element with high thermal conductivity in the airborne vehicle so as to act as an antenna pole.
